(19) United States
(12) Patent Application Publication
(10) Pub. No.: US 2016/0127928 A1
(43) Pub. Date: May 5, 2016

(54) ALERT DEVICE SYSTEM AND METHOD

(71) Applicants: Neil L. McClure, Longmont, CO (US); Ralph David Wieland, Broomfield, CO (US)

(72) Inventors: Neil L. McClure, Longmont, CO (US); Ralph David Wieland, Broomfield, CO (US)

(21) Appl. No.: 14/738,800

(22) Filed: Jun. 12, 2015

Related U.S. Application Data
(60) Provisional application No. 62/072,600, filed on Oct. 30, 2014.

(51) Int. Cl. H04W 24/08; G06F 11/07; H04M 1/725; H04W 24/02; H04W 4/00

(52) U.S. Cl. CPC H04W 24/08; H04W 24/02; H04W 4/008; H04M 1/72527; G06F 11/0751; G06F 11/0772

(57) ABSTRACT

A mobile device is provided with software monitoring a programmatically controlled process of the mobile device. The software communicates a status of the process to an alert device that, in turn, communicates process status information to the monitor. The monitor is equipped to take appropriate action, such as by providing notifications if operation of the process has failed, rebooting a program on the mobile device to restart the failed process, rebooting an operating system of the mobile device to restart the failed process, or providing programmatic instructions to alter operation of the process according to a pretermined schedule or sequence of events.

### CROSS-REFERENCE TO RELATED APPLICATIONS

This application claims the benefit of priority of U.S. Provisional Application Ser. No. 62/072,600 filed Oct. 30, 2014, which is incorporated herein by reference.

### BACKGROUND

1. Field

The present disclosure pertains to systems that advance user-system interaction and utility. More specifically, the system utilizes electromechanical systems and software to introduce a new monitoring and alarm methods to extend the utility, reliability and safety of mobile computing devices when used as a user interface extension as part of a larger software system.

2. Description of the Related Art

Mobile devices, such as cell phones, smart phones, tablet computers, wireless communication and computing devices, wearable sensors, wearable detectors and instruments based on the Internet of Things are widely adopted. The ability to install custom software applications (“apps”) on these mobile devices permits the apps to operate as a component of larger software systems that operate remotely. The ubiquitous presence of mobile devices leads system designers to capitalize on this ‘free’ hardware platform by creating apps that interface with larger software systems in real time. This trend of extending the user interface of software systems to mobile devices increases as it brings improved utility and convenience to users.

This trend creates also new challenges. For example, as implementations extend to software systems that support critical processes and human life, the consequences of system failure may be extreme. The independence of mobile device that make them attractive as user interface extensions also makes them dangerous.

The typical implementation of a user interface extension app has the mobile device software application downloaded to the mobile device, where the app supports wireless communication, including but not limited to cellular, Wi-Fi and Bluetooth transmissions. A central software application that typically operates on a fixed computer system or network is ‘mobile enabled’, allowing it to communicate with mobile devices. If the central software application is involved in support of critical processes or human life, there are many well-known techniques employed to ensure the reliability and availability of the central system. When mobile devices are added to this system as user interface extensions however, a loss of control occurs given the independent nature of the mobile device. The most notable area where control is lost involves the situation where the mobile device experiences an error, causing the mobile device to ‘lock up’, yet the mobile device continues to display the last update received from the central system and the user is unaware of the error condition.

This situation is currently uncorrectable because, when the mobile device locks up, the mobile device is unable to notify the user of the error or automatically reset. The use of mobile devices as user interface extensions presents a tremendous opportunity for improved utility for both system designers and users however, to allow this trend to continue there is a need for a mobile device watchdog capability to ensure a safe and reliable implementation of mobile devices as user interface extensions. When used in relation to hardware and software, the term watchdog, or watchdog timer, is used to describe a function that is implemented in any combination of hardware and software where the typical operation includes a timer that is periodically restarted by the system and if not restarted, will reset the system or otherwise produce an error.

US patent publication number 2014/0321448 to Backholm, et. al. discloses a method of monitoring network communication artifacts and applying statistical analysis techniques to the collected information to maintain long-lived communication connections. This is an indirect approach and does not result in the level of operational assurance provided by the present disclosure. US patent publication number 2013/0145010 to Luna et al. presents a fail over mechanism for managing communication connection faults. Luna does not include application support or notify users of errors or loss of communication. US patent publication number 2013/0317837 to Ballentyne et al. provides a wearable system monitor that can interrogate other system devices in a traditional watchdog-type function that does not account for loss of communication or alerting the user to such a condition. A watchdog is operably connected to the wearable system monitor processor while it interrogates other system devices. Nothing in Ballentyne alerts the user of the other system devices if the wearable monitor detects a malfunction.

In U.S. Pat. No. 8,539,283 to Kady et al. the disclosure presents a high reliability system for use in automobiles to support emergency conditions. Kady presents alternate embodiments that contain two separate modules, in different combinations of hardware and software, that cooperate together to form a high reliability monitoring and reporting system. One of the modules is connected to a mobile device to notify remote support resources that an emergency event has occurred. The high reliability elements of Kady do not include the mobile device in the processing loop and therefore a failure of the mobile device can occur and go undetected.

U.S. Pat. No. 8,769,351 to Li uses redundant User Identity Modules (UIM) chipsets internal to the mobile device to monitor communication and response times between the UIMs in an effort to correct errors. If the timing exceeds a predetermined value, one of the UIMs is reset by a watchdog, which in turn resets the second UIM, clears the buffers and resends the communicated message. This method has a very limited application and requires a unique hardware configuration that prohibits its use with general purpose mobile devices. US patent publication number 2008/0091819 to Yang discloses a hardware and software system for monitoring network devices using a standard Ethernet network communication command and cycling the network device power if it's found to be inactive. Yang only provides a one-way monitoring capability and does not result in a fail-safe condition for the failure or malfunction of any of the hardware components that are part of the disclosed method. Further, Yang does not possess the means to communicate with users and it is limited to power cycling the hardware components.

US patent publication number 2013/0157571 to Wondka et al. presents a well formed section on the background and need for remote, wireless monitoring of medical devices however, it overlooks the critical capability contemplated by the present disclosure. Wondka includes six main embodiments, including a universal wireless transmitter and remote receiver; alarm differentiation protocols to distinguish/prioritize different alarm types; wider-area network for communication with remote persons; power management protocol to reduce power consumption and extend battery duration; prevent cross-talk between different systems; single receiver which may simultaneously receive, differentiate between, process and display multiple signals that are transmitted from multiple transmitters. Wondka also points out that there are no completely cross-compatible alarm monitoring devices that operate with different brands and models of medical devices and that eventually there may be a universal standard for monitoring medical equipment with PDA type devices, such as DROID™ smart phones.

U.S. Pat. No. 8,832,827 to Herscovitz et al discloses a system and method for detection and recovery of malfunction in mobile devices, where “sensors” are used to monitor the operational status of mobile device and/or one or more of its resources. The sensors are disclosed as any software, hardware, firmware and/or any combination of these that is capable of monitoring the mobile device and/or its resources for information that would possibly indicate that resources have been affected or the occurrence of suspicious activity (column 8, line 14). The sensors of Herscovitz passively monitor the mobile device and/or its resources and when information received by the sensors meets certain, pre-defined criterion, other actions are initiated (column 5, line 40). Monitoring of the mobile device and/or one or more resources can be performed by variety of methods, but in all instances, the sensors receive information that exists as part of the regular operation of the mobile device or resources. Furthermore, the criteria disclosed by Herscovitz are only indicative of a possible suspicious event and do not specifically communicate a problem occurring within the overall system. These criteria are subjective measures of possible failure. Additional process steps are required to determine if an event in progress warrants additional action be taken.

This type of passive monitoring of the mobile device is insufficient to support more critical applications where a user must be immediately notified, and with certainty, of any failure or malfunction. Moreover, Herscovitz focuses upon virus detection and the protection of data rather than fail-safe operation of communications between nodes of a system used for critical applications. There is a need for a more robust and active monitoring of mobile devices that transforms the measure of reliability in the range of a “fail-safe” device.

A growing number of applications utilize mobile devices as extensions of the user interface where the reliability is critical to minimize the loss of life and property. For these emerging applications, failure of a mobile device or momentary loss of communication can have a catastrophic impact. The lack of fail-safe mobile devices prevents the growth of these types of applications, preventing also the introduction of new levels of utility for users.

The loss of communication or “freezing” of mobile devices is evidenced by the Amazon Kindle, a tablet device that claims to represent 33% of the ANDRIOD™ tablet market in October of 2013. Among the Kindle's top seven user problems is that the device freezes or hangs when in operation. This problem is attributed to multiple possible sources and demonstrates the risk associated with using generic mobile devices as user interface extensions for critical applications, such as hospital patient monitoring systems. Other possible failure modes are simply overloading the system microprocessor with too many applications running simultaneously that causes a specific application to fail or interaction with other loaded applications which overload the system microprocessor or otherwise reduce or prevent access to system resources. There are likely situations where hardware clones use substandard components or different component manufacturers that introduce slight variations of functional operation or performance.

Another drawback of the current art is that mobile device Operating Systems (OS) are intentionally designed to shut down or automatically put applications into a sleep mode under certain conditions to conserve battery life. This poses risks for applications that are part of a critical monitoring application.

Given the ubiquitous nature of mobile devices and plethora of manufacturers, it is impossible to test all combinations of devices and software. This situation is further exacerbated with open source nature of the Android operating system and the release of new versions that may or may not be loaded on a target device or tested with a particular application. Lastly, security concerns are ever present in the digital world and mobile devices are not immune to the threat of hackers. Critical applications running on mobile devices are an attractive target for hackers whose interests are, at a minimum, notoriety. The foregoing situation clearly identifies a need for an independent method for monitoring a mobile device application that is part of a larger system that involves the safety of life and property.

### SUMMARY

The presently disclosed instrumentalities overcome the problems outlined above and advance the art by providing a simple, standalone device, hereinafter an “alert device,” that communicates with a mobile device to ascertain the operational status of the mobile device or the status of a software application running on the mobile device. The alert device provides additional communications indicating a failure if the mobile device appears not to be operating properly.

In one embodiment, the alert device is independent of the mobile device that is running a critical application and requires the critical application to communicate with the alert device. The alert device is independent because it has completely separate software, hardware and mechanical packaging and may communicate with the mobile device through any number of well-known communication methods.

In one aspect, the alert device communicates with the mobile device, either wirelessly or through a direct connection, in order to monitor the operational status of one or more software applications running resident on the mobile device. It is also possible to monitor the operational status of the mobile device. An alarm or alert is issued by the alert device if any abnormal operation occurs with one or more of the monitored software applications and/or with the mobile device, including loss of power. When any of these conditions occur, the alert device alerts the user to a potentially dangerous condition if the mobile device is being operated as user interface extension for a critical software application. The alert device communicates with a mobile monitoring application that has been downloaded and runs resident on the mobile device, and which operates independently of any other program on the mobile device, including any application that configures the mobile device as a user interface extension.

In one embodiment, the alert device integrates with mobile devices in an unobtrusive electrical and mechanical manner such that the portability of the mobile device is not inhibited. This mitigates the aforementioned limitations and solves the reliability problem for mobile devices, including smart phones, without the need for the adoption of industry wide standards for mobile device hardware and software.

In one aspect, the mobile device may also monitor the alert device to provide system redundancy, creating a fail-safe system. Further, the preferred embodiment is capable of monitoring an individual resident software application on the mobile device, moving the error detection capability to application level error conditions to provide a significant improvement in overall system reliability and safety.

### BRIEF DESCRIPTION OF THE DRAWINGS

FIG. 1 is a system schematic diagram according to one embodiment of the presently disclosed instrumentalities;

FIG. 2 is a system schematic diagram of a communication subsystem according to one embodiment;

FIGS. 3a and 3b are process flow diagrams according to one embodiment of the presently disclosed instrumentalities;

FIG. 4 is a system level diagram of a communications subsystem;

FIG. 5 is a system level diagram of a communications subsystem; and

FIG. 6 is a system level diagram of a communications subsystem.

### DETAILED DESCRIPTION

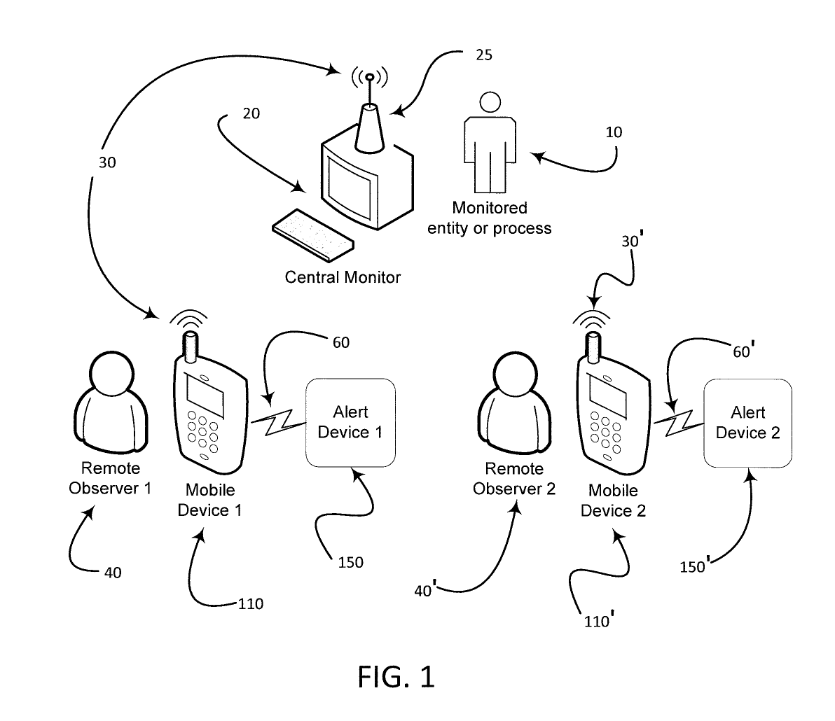

FIG. 1 provides an overview of the system-level application that the present disclosure addresses. This system-level application contains a central monitor 20 that performs a critical function for a monitored entity or process 10. The monitored entity or process 10 can be any situation that must be supervised, attended to or monitored to ensure that certain conditions are maintained or addressed. The monitored entity or process 10 may be, for example, a person in a medical facility, someone who is involved in a hazardous endeavor or activity whose condition must be known, an activity involving animals or any type process involving other machinery and materials. The central monitor 20 is equipped with a wireless communication transceiver 25 having the ability to transmit and receive wireless communication signals 30 that are commonly used by wireless devices, as is well known in the art.

Also shown in FIG. 1 is mobile device 110 that is in possession of a remote observer 40, where the remote observer 40 has an interest or requirement to maintain knowledge of the monitored entity or process 10 through the use of central monitor 20. Remote observer 40 may also be required to exercise control over central monitor 20 by changing or altering operating parameters of the central monitor 20 through the input of information through mobile device 110. Central monitor 20 transmits wireless communication signals 30 that contain relevant information regarding the status of the monitored entity or process 10. Mobile device 110 receives the wireless communication signals 30 and the information contained in the signals is used by a resident software application on the mobile device 110 to communicate the information to the remote observer 40 about the monitored entity or process 10.

To improve the reliability and security of the overall system-level application, an alert device 150 is used to monitor the mobile device 110 and provides independent error reporting to the remote observer 40. Preferably, mobile device 110 and alert device 150 communicates via wireless channel 60 that can use a variety of transmission technologies where the communication includes a signal from the mobile device 110 that updates or resets a watchdog timer operating on alert device 150. In the same manner, the central monitor 20 communicates with another mobile device 110, which may include additional hardware or software that provides monitoring capability for the monitored entity or process 10, utilizing wireless communications signals 30 and alert device 150 to notify remote observer 40. This may be repeated for a second remote observer 40′ using a second mobile device 110′ monitored by a second alert device 150′ using mobile communications 60′. It will be appreciated that the alert devices 150, 150′ may each communicate with transceiver 25 using signals 30′. Also, in some embodiments, the alert devices 150, 150′ may be replaced by a single alert device (not shown) that communicates with mobile devices 110, 110′ using wireless signals 60, 60′ respectively allocated to a corresponding one of mobile devices 110, 110′.

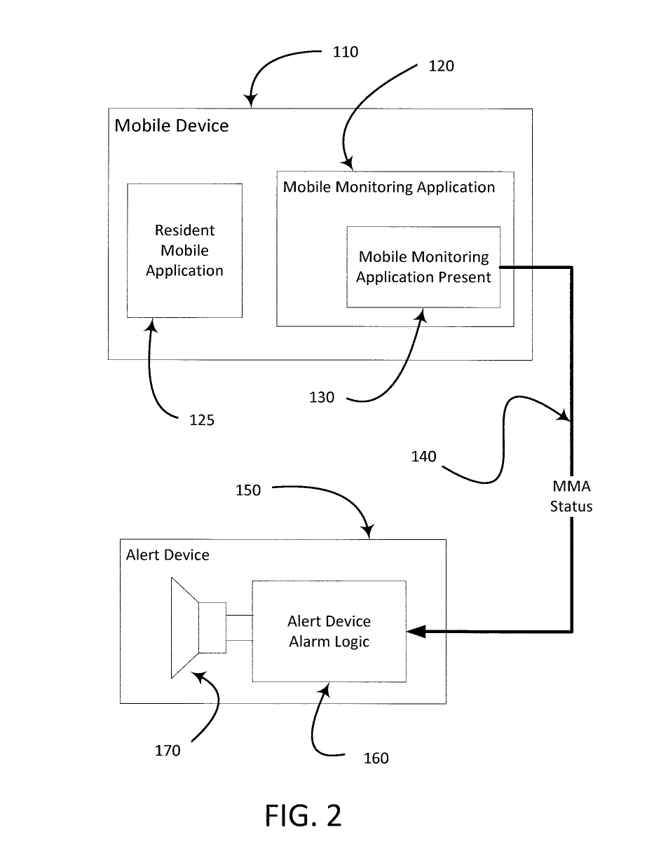

FIG. 2 is a system level diagram of the components utilized by the remote observer 40 according to one embodiment. The mobile device 110 may be a commercially available device, for example, as any type of cell phone, smart phone, tablet computer or other wirelessly communicating computing device. Mobile device 110 utilizes an Operating System (OS), such as a conventional operating system known in the art, which manages the hardware and software resources, including resident memory and wireless communication capabilities, as well as Bluetooth, Wi-Fi, near field communication (NFC), Radio Frequency Identification (RFID) and a variety of protocols through direct electrical connection.

The mobile device 110 is partially configured by a custom mobile monitoring application 120 that is a software application developed according to the presently disclosed instrumentalities. In one aspect, the application 120 may be downloaded, stored in the resident memory of the mobile device 110 and presented for use by a remote observer 40. For example and as is well known in the art, software application programs may be started automatically by the mobile device OS or upon user demand, for example, by remote observer 40.

The presence of the mobile monitoring application 120 on the mobile device 110 signifies that mobile device 110 is used as part of a multi-component system that facilitates additional monitoring for safety and reliability concerns. In a preferred embodiment, use of the mobile monitoring application 120 is in conjunction with an additional mobile application 125 that resides on mobile device 110. The mobile device 110 utilizes mobile application 125 to communicate with the system level central monitor 20 given in FIG. 1 where the central monitor 20 is remote from mobile device 110. The resident mobile application 125 communicates with the remote observer 40 to create a user interface extension of the system level central monitor 20.

In one embodiment, the mobile monitoring application 120 optionally launches automatically when the mobile device is turned on so that the mobile monitoring application 120 runs when the mobile device 110 is in use. Alternatively, the mobile monitoring application 120 may be configured to launch in unison with the resident mobile application 125 that puts the mobile device in an operating condition. The resident mobile application 125 may contain computer code operating on an assumption that the alert device 150 and mobile monitoring application 120 are operable and fully functioning, with periodic checks being made among the system components to confirm this is so. By way of example, the resident mobile application 125 may cause mobile device 110 to poll alert device 150 and/or monitoring application 120 by prompting a handshake reply to confirm that all systems are active. Any one device on the system may initiate a handshake confirmation from any other device. Alternatively, any device on the system may transmit to one or more other devices within designated intervals to confirm operability.

Mobile monitoring application 120 also includes computer code that utilizes one or more of the mobile device 110 communication capabilities, including Bluetooth, Wi-Fi, near field communication and a variety of protocols through direct electrical connection, such as USB or the headphone/microphone connector. The communication path is shown in FIG. 2 as notification 140. Mobile Monitoring Application (MMA) Status 140 may utilize a wireless signal notification, for example, using Bluetooth, or communication may use a wired path.

Also shown in FIG. 2, alert device 150 is, broadly, circuitry under operational control of program instructions constituting alarm logic 160, which interfaces with the mobile monitoring application 120 to provide alarms, alerts or other such notifications as needed concerning the operational status of resident mobile application 125. This may be, for example, a plug-in software module either for central monitor 20 or else a mobile device 110 that operates using the operating system of the electronic system to which the plug-in software module is attached. Preferably, the alert device 150 is a standalone or independent device housing simple circuitry for communicating with mobile device 110, and other customary components useful for the functioning of an electromechanical device. This includes alert device alarm logic 160 that drives functionality to produce a variety of possible alert or alarm types or otherwise communicate with a remote observer 40 through output notification 170, preferably under the control of a separate operating system other than an operating system of the central monitor 20 or mobile device 110. The mechanical form of the alert device 150 is more preferably such that it integrates with mobile devices in an unobtrusive electrical and mechanical manner to maintain the portability of the mobile device 110 and has a power source independent of central monitor 20 and mobile device 110.

In one embodiment, a smartphone provides the mechanical form of the alert device to be similar to commercially available protective cases, such as the Tough Jacket™ manufactured by the Ballistic Case Company of Sunrise, Fla. As will be recognized by those skilled in the art, there are many mechanical forms that will satisfy the mechanical packaging intent as disclosed herein. Further, the alert device is not required to be in physical contact with the mobile device. For example, if an application were deployed to GLASS™, a mobile device made by Google, mounted to a pair of glasses, the alert device 150 can be integrated into a retainer that maintains the position of the glasses on the user's head. As the mechanical form factor of the mobile device 110 varies, so may the mechanical form of the alert device to satisfy the positional requirements disclosed, as will be recognized by those skilled in the art.

In operation, the alert device 150 is attached, adjacent or is otherwise in proximity of mobile device 110 when mobile device 110 is powered on, which optionally launches the mobile monitoring application 120. If a specific, third-party resident mobile application 125 is configured to operate in unison with the mobile monitoring application 120, mobile monitoring application 120 starts when the third-party resident mobile application launches. In this instance, the resident mobile application 125 integrates the mobile monitoring application 120 communication command set in order to communicate directly to the mobile monitoring application 120. In its most basic configuration, mobile monitoring application 120 is a device driver that provides a software interface for the alert device 150 hardware. Alternately, the mobile monitoring application 120 can collect status information directly from the resident mobile application 125 by receiving existing operational artifacts output by the resident mobile application 125 or can monitor its status through the operating system. Monitoring through the operating system can be accomplished through a variety of well-known techniques practiced in the art.

From a security perspective, the preferred embodiment is to employ the resident Near Field Communication (NFC) capability such that when mobile device 110 is powered, the mobile monitoring application 120 activates the NFC through MMA Status 140 and looks for a response from alert device 150, indicating its presence. NFC has the advantage that in order for any separate device to communicate with mobile device, the separate device must be in very close proximity to mobile device, and in most cases, the two devices must be in direct contact. From a practical perspective, Bluetooth is more commonly available and is an equally effective communication method but can be received at greater distances, making it susceptible to eavesdropping and hacking. With a greater range, Bluetooth will also introduce the possibility that the two devices become physically separated beyond the range of transmission without alerting the user that the communication has been lost. Both communication technologies include a handshaking protocol between devices that establish the connection and provide evidence that the alert device is present and operational. As will be understood by those skilled in the art, other forms of communication between the devices are possible including Wi-Fi, optical or a direct cable interconnect.

Once the communication link between mobile device 110 and alert device 150 is established, the system transitions into a run-time mode of operation, where the mobile monitoring application 120 includes the “mobile monitoring application present” 130 that sends a repeating, periodic message via MMA Status 140 path to alert device alarm logic 160 indicating the mobile monitoring application 120 is operating normally. If alert device alarm logic 160 fails to receive a message in the prescribed time period, or the message indicates abnormal operation, alert device alarm logic 160 activates the output notification 170 to alert the remote observer 40 to an error condition.

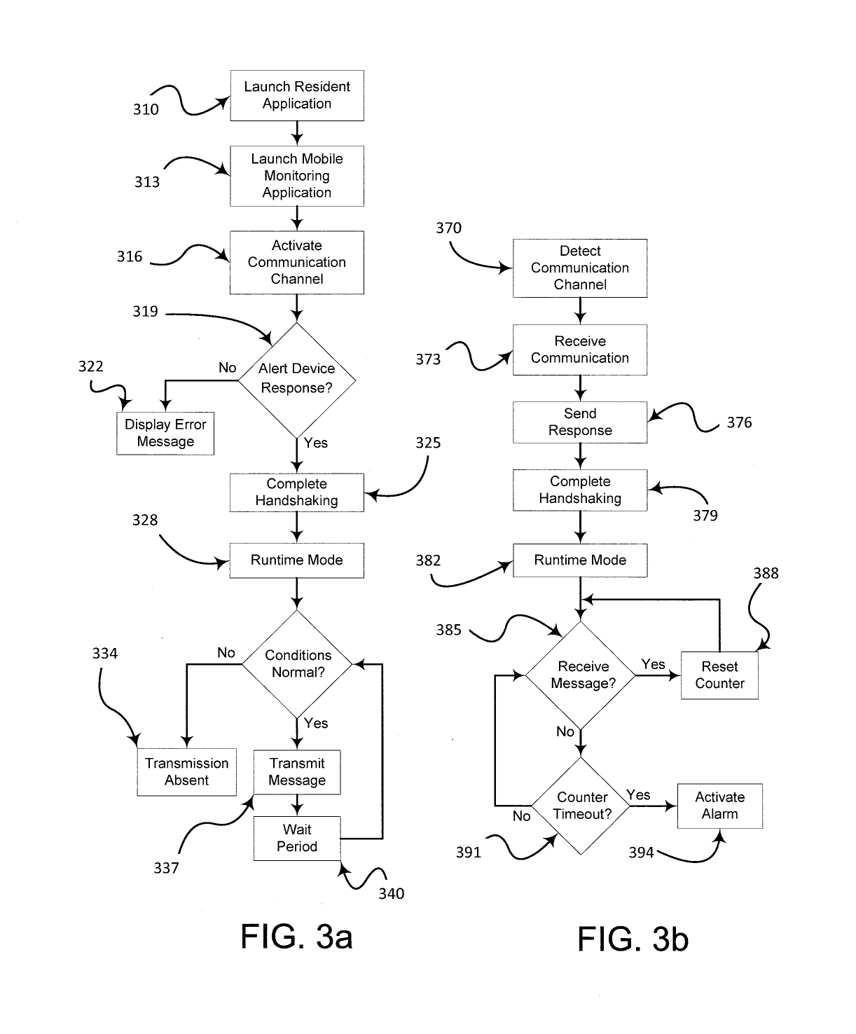

The foregoing operational description of the interaction between the alert device 150 and mobile device 110 is described in greater detail below and graphically in FIGS. 3a and 3b. FIG. 3a shows a representative process flow for the mobile device 110 that begins with Launch Resident Application 310. As previously disclosed, Launch Resident Application 310 can be initiated by applying power to the mobile device or it can be launched by an operator or Remote Observer 40. Launching Application 310 causes the mobile monitoring application 120 to start in Launch Mobile Monitoring Application 313. With both applications running on the mobile device 110, the mobile monitoring application 120 begins transmitting a message through the mobile device 110 wireless channel 60 to the alert device 150. The mobile monitoring application 120 monitors the wireless channel 60 for a response from the alert device 150 in process step Alert Device Response? 319 and if none is received, the mobile monitoring application 120 generates an error message indicating that no response was received from the alert device 110 in the Display Error Message 322. If it is determined that the alert device 110 provides a response 319, then the process moves forward to complete handshaking 325, which establishes an on-going communication wireless channel 60 between the mobile device 110 and alert device 150. With wireless channel 60 operational, the mobile monitoring application 120 transitions into Runtime Mode 328, where the mobile monitoring application 120 transmits periodic MMA Status 140 messages to the alert device 110. If the mobile monitoring application 120 continues to operate normally, MMA Status 140 is sent in Transmit Message 337 and the periodicity is defined by Wait Period 340. If any abnormal conditions occur, MMA Status 140 is not sent and the process ends with Transmission Absent 334. The process flow of FIG. 3a runs on the mobile device 110 while the complementary process flow runs on the alert device 150 as given in FIG. 3b and described below.

The alert device 150 may be powered by batteries or RF energy harvesting and when power is applied, the alert device 150 immediately looks for the presence of a signal through wireless channel 60 as shown in Detect Communication Channel 370 block of FIG. 3b. When a signal is detected, the alert device 150 verifies it was sent from the mobile monitoring application 120 in process step Receive Communication 373. The alert device 150 acknowledges the signal is correct by responding to the mobile monitoring application 120 in Send Response 376 that then results in Complete Handshaking 379 to secure a persistent wireless channel 60. As with the mobile device process flow in FIG. 3a, the alert device 120 transitions in Runtime Mode 382, where it goes into a process loop to look for messages from the mobile monitoring application 120 in decision block Receive Message? 385. If a message is received, Reset Counter 388 initializes the counter to its default value and it begins counting again. If no message is received, the alert device determines if the counter has depleted in Counter Timeout 391 and if it hasn't, continues to look for a message in Receive Message 385. If not message is received and the counter has timed out, Active Alarm 394 is triggered to notify the Remove Observer that an abnormal condition has occurred.

The embodiment given in FIG. 2 is a simple form of the present system that provides utility and an improvement to the art. The likely implementation is where reliability is critical, so the preferred embodiment incorporates additional functionality to provide ‘fail-safe’ functionality. In the present context, fail-safe is applied to mean that if either the mobile device 110 or alert device 150 fails, the remote observer 40 will be notified so the use of the devices will be discontinued to minimize the risk to property and personnel.

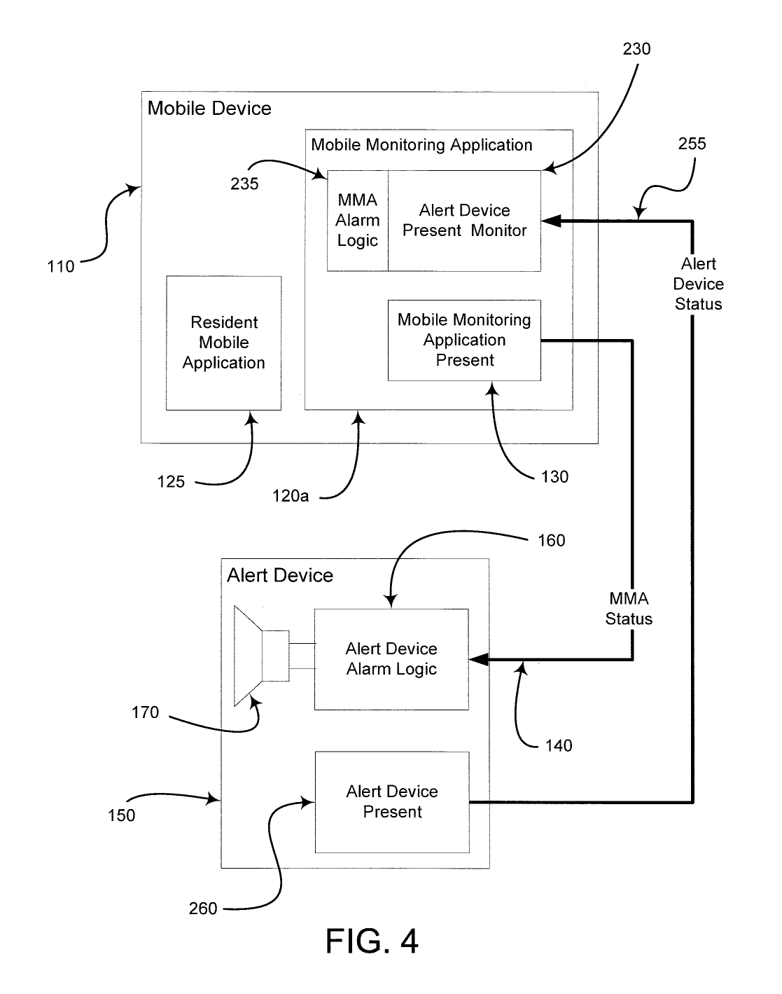

The embodiment of FIG. 4 includes the mobile device 110, mobile monitoring application 120a and alert device 150, as given in FIG. 2. The embodiment of FIG. 4 establishes bi-directional monitoring of the mobile device 110 and alert device 150 so that if either device fails, the operator/owner is notified. The embodiment in FIG. 2 is present in FIG. 4, which adds a mirrored functionality for elements 130, 140 and 160. As in FIG. 2, elements 130, 140 and 160 communicate the operational status of mobile monitoring application 120a to the alert device 150.

To support the fail safe context, the alert device 150 must be monitored and is diagramed in FIG. 4 to provide a robust two-way monitoring with notification and status reporting redundancy. Elements 260, 255, 230 and 235 combine to perform the same pathway function as elements 130, 140, 160 and 170, except in the reverse direction such that the mobile device 110 is monitoring the status of the alert device 150 and the mobile device 110 reports the absence and/or occurrence of any abnormal conditions. Algorithm Alert Device Present 260, a component of alert device 150, generates an Alert Device Status signal 255 that is transmitted to mobile device 110 via pathway 60 and is received by the functional block alert device present monitor 230. This bi-directional monitoring down to the level of individual resident mobile applications 125 provides the reliability necessary to support the trend of mobile devices being used as user interface extensions.

In one aspect, an important operational element of mobile device use may be the power source for the device, which is generally based on a form of battery technology. The preferred embodiment is to power the alert device 150 with rechargeable batteries developed for mobile devices, thereby providing a similar maintenance and charging requirement. Further, given the limited functionality provided by the alert device 150, the power consumption will be lower than the mobile device 110 that increases the likelihood the mobile device 110 will deplete its battery before the alert device 150, elevating the reliability of the alert device 150 reporting an error or malfunction. Other battery technologies are contemplated by the present disclosure, including disposable lithium-based material combinations, alkaline, and other materials that are packaged in commonly available cell formats including A, AA, AAA and coin cells.

Also contemplated as possible power source by the present disclosure is the use of Radio Frequency (RF) energy harvesting, where ambient RF energy is converted to DC voltage to provide power for electronic circuits. Widely used for RF identification tags, the RF energy harvesting technology continues to improve the efficiency of the conversion of RF energy into useable DC voltage, and when coupled with the reduction in required operating voltage of integrated circuits, harvested RF energy is a viable power source for the alert device 150. For the mobile device 110 to be operational, it must be in proximity of an RF signal of sufficient strength to communicate wirelessly. This signal is able to generate enough energy for the alert device 150 to convert to DC voltage for power. Other RF signals may be present, including those emitted from the mobile device 110. To ensure against sudden loss of RF energy that would render the alert device inoperable in this embodiment, an energy storage component, such as a super capacitor, is added to the alert device and charged while RF energy is present. If a sudden loss of RF energy occurs, the energy stored in the storage component is used to drive the output notification 170 or WW Action Block 275 to inform the user of an error condition or malfunction.

Another aspect may be that the alert device 150 does not drive, direct, initiate or otherwise control any functional aspect of the mobile device 110 or resident mobile application 125. This is noteworthy for two reasons, the first of which is that it allows the alert device 150 to maintain its independence from the mobile device 110 and resident mobile application so that failure modes do not become inter-dependent. A second aspect is that if the alert device 150 were to execute any control over the mobile device 110 or the resident mobile application 125 then the alert device would become subject to the requirements and regulatory issues bound to the mobile device 110 and resident mobile application. Further, the alert device 150 is essentially a hardware device running a software application that typically does not have a display for visual information but is capable of communicating with a mobile device 110 for interactive operation.

It is expected that once the alert device 150 becomes commercially available and the need for fail-safe mobile device operation is demonstrated, system designers and developer will incorporate the use of the alert device 150 into the development and operation of their resident mobile application 125. The software communication and command set for the alert device 150 will be publicly available, for example as an Application Program Interface (API), so that system designers can capitalize on the full functionality offered by the alert device 150 by integrating an interface directly in their resident mobile applications 125.

By way of a non-limiting example of an architectural implementation of the present instrumentalities, alert device 150 is a system that includes a block of software code that runs external to the alert device 150 and is provided as an Application Programming Interface (API). The API is made a part of the resident mobile applications 125 by linking the API into the resident mobile application 125 by the developers, a technique that is well known in the art. In this case there is only one application as the mobile monitor application 120/120a is integrated into the resident mobile application 125 and it communicates with the alert device 150. The developer creates the application and must make appropriate calls to the API to enable, disable and send notifications to the alert device 150.

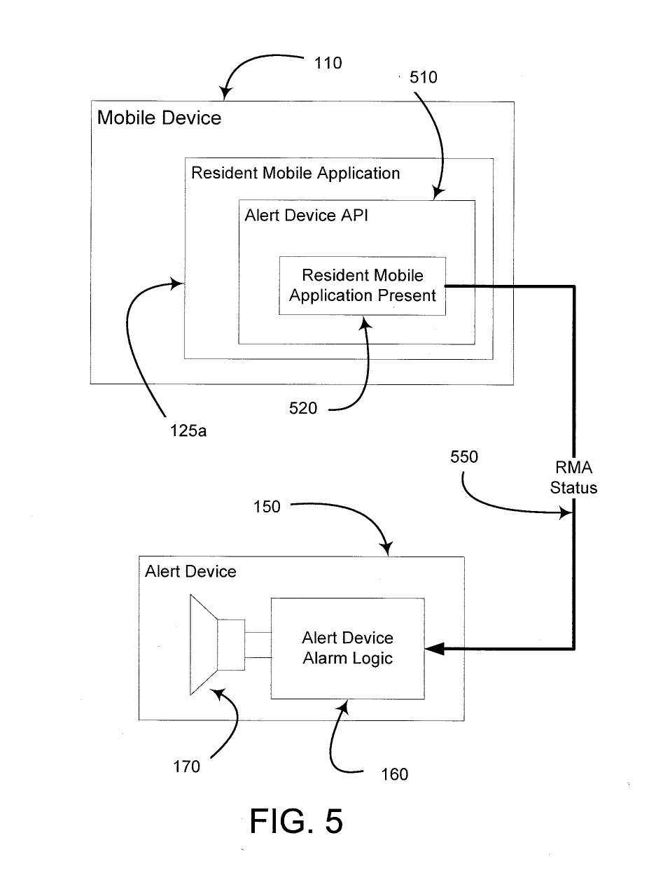

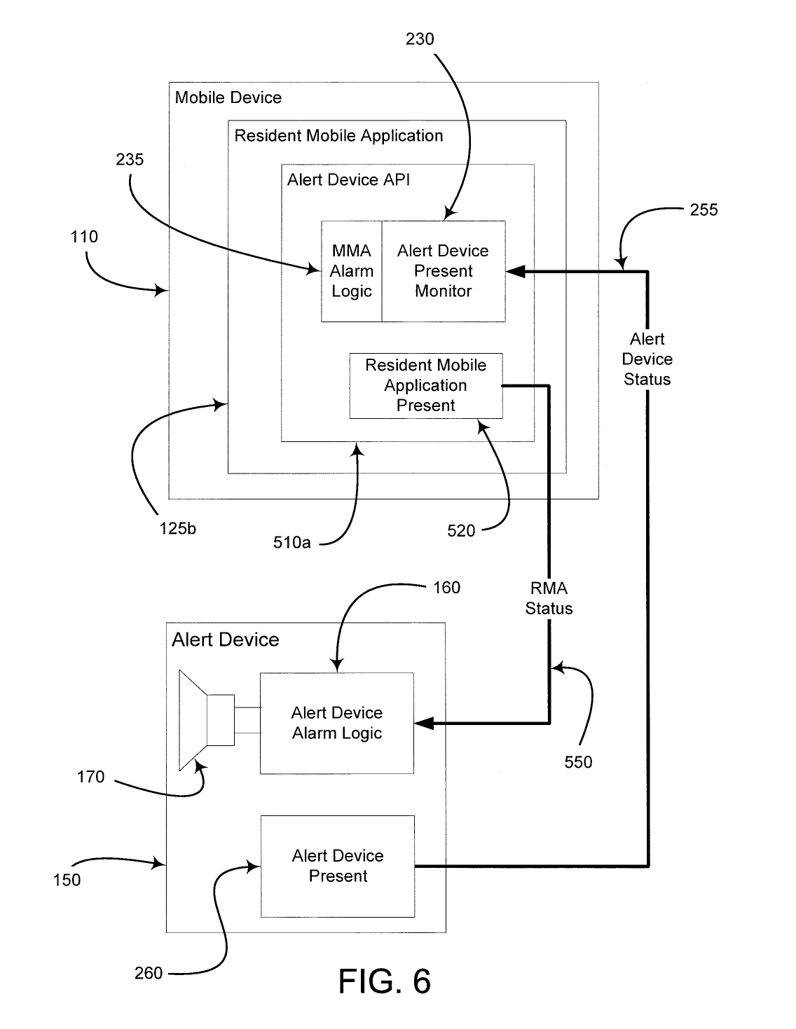

As shown in FIG. 5, alert device API 510 has been integrated into the resident mobile application 125a and become a component of the application. This alternate embodiment permits the resident mobile application 125a to communicate directly with the alert device 150 using the resident mobile application present 520 function that is part of the alert device API 510. Yet another alternate embodiment is shown in FIG. 6, where alert device API 510a includes MMA alarm logic 235 and alert device present monitor 230 as in FIG. 2. Since in this embodiment, the resident mobile application 125b is communicating directly to the alert device 150, the alert device API 510a outputs the RMA status 550 from the resident mobile application present 520. The advantage to the approach using an API is that all code associated with the resident mobile application and the mobile monitoring application are encapsulated into a single code base for a more tightly integrated implementation. The resident mobile application 125a/125b is responsible for interacting with the mobile device 110 and managing the necessary mobile device 110 resources needed by the alert device API 510/510a. This is contrasted by the embodiment of FIG. 2 and FIG. 4, where the mobile monitoring application 120/120a runs standalone on the mobile device 110 so it must manage the necessary mobile device 110 resources.

A manufacturer of a mobile device 110 or a developer of a resident mobile application 125 can require the use of the alert device 150 with their product(s) without the need to sell or manufacture an alert device. As demonstrated by other markets with products governed by standards, the alert device can be produced by multiple vendors based on the publicly available interface specification. The standard interface of the alert device 150 allows the developer of resident mobile applications 125 to specify that a compliant alert device 150 is required to use the resident mobile application 125. The aforementioned situation also addresses potential problem caused by variations among mobile devices. For example, there are instances where a mobile device 110 is operating nominally, but the resident mobile application 125 has locked up and is frozen. This condition is generally supposed to be handled by the OS, but the response produced by the OS for the user (e.g. a dialog that says “application taking too long, do you want to continue to wait?”) may not be appropriate, guaranteed to be the same across all mobile devices 110 or comply with a regulatory requirement for a particular market (e.g. FDA standards for medical device alarms). The present instrumentality addresses this problem by providing a standardized response to a locked up application and other error conditions that is independent and immune to the perturbations of performance found across all mobile devices.

There is another architectural configuration supported by the present disclosure, where an external hardware device is connected or interfaced directly to mobile device 110 to create a critical application without a central monitor. For example, a wearable respiratory sensor can communicate locally with a mobile device using Bluetooth to transmit respiration and heart rate. The mobile device can then wirelessly transmit this information to a cloud service that would allow other remote users 40 to monitor the patient vital signs remotely. In this configuration, the mobile device 110 coupled with an external hardware device is monitored by the alert device 150 for nominal operation.

In yet another contemplated embodiment, monitoring of the operational status of resident mobile application 125 can be performed and reported by mobile monitoring application 120 without the use of an independent alert device 150. In this situation, the mobile monitoring application 120 runs on the mobile device 110 and monitors the resident mobile application 125 for any anomalous conditions or anything that impedes it's operational status. For example, mobile device operating systems (OS) will automatically put applications to sleep after periods of inactivity with a user and this is a likely condition for a resident mobile application 125 that is part of a user interface extension. Further, mobile device OS will automatically shut down applications if resources (memory) becomes limited. Both these situations pose a danger when the mobile device is running a resident mobile application 125 used for remote monitoring. If a situation similar to those just outlined occurs, the mobile monitoring application 120 is able to activate an alert for the user since the mobile monitoring application 120 was designed to immune to sleep mode or automatic shutdown.

Those skilled in the art will understand that the disclosed embodiments, as hereinabove described, may be subjected to apparent modifications or insubstantial change without departing from the true scope and spirit of the invention. The inventors, accordingly, hereby state his intention to rely upon the Doctrine of Equivalents, in order to protect their full rights in the invention.

What is claim is:

1. A system comprising:
a monitor that is constructed and arranged for communicating with a mobile device;
an alert device separate from the mobile device;
a software application running on the mobile device for programmatic control of communication with the monitor;
wherein the software application periodically communicates its operational status to the alert device, and
the alert device being programmed with logic for delivery of notification commensurate with the operational status of the software application.

2. The system of claim 1, wherein the mobile device includes a software application that has been downloaded to the resident memory of the mobile device.

3. The system of claim 1, wherein communication between the mobile device and alert device is performed wirelessly; Bluetooth; Near Field Communication.

4. The system of claim 1, wherein communication between the mobile device and alert device performed through a wired connection.

5. The system of claim 1, wherein the monitor collects parameters related to a patient under medical care and wirelessly transmits the parameters to a software application resident on a mobile device.

6. The system of claim 1, wherein the monitor collects parameters related to a process involving machinery and/or materials and wirelessly transmits the parameters to a software application resident on a mobile device.

7. The system of claim 1, wherein the monitor collects parameters related a person, animal or other entity that requires monitoring and wirelessly transmits the parameters to a software application resident on a mobile device.

8. The system of claim 1, wherein the software application communicates to a remote observer the parameters transmitted by the monitor received by mobile device.

9. The system of claim 1 wherein the mobile device is used by a remote user that is responsible for the monitored patient, process, person, animal, entity.

10. The system of claim 1, wherein software application starts automatically when the mobile device is turned on.

11. The system of claim 1, wherein the software application is started by an owner/operator of the mobile device.

12. The system of claim 1, wherein the alert device is mechanically coupled to mobile device.

13. The system of claim 1, wherein the alert device is mechanically mounted a fixed distance from the mobile device.

14. The system of claim 1, wherein the software application communicates its operational status to an alert device.

15. The system of claim 1, wherein the alert device communicates its status to a software application.

16. The system of claim 1, wherein the software application contains the communication means for the alert device.

17. A system, comprising:
a central monitoring system with wireless communication capability used for monitoring an entity or process;
at least one mobile device in communication with the central monitoring system, said communication containing parameters associated with the monitored entity or process;
the mobile device being capable of communicating the parameters through a software application that presents the parameters to a user through a graphical user interface of the mobile device;
an independent alert device in communication with the mobile device;
wherein the communication between the mobile device and the independent alert device indicates of the operational status of the mobile device and/or the software application;
the independent alert device producing an alarm condition if the operational status of the mobile device and/or the software application indicates an error condition.

18. The system of claim 17, wherein the mobile device includes a software application that has been downloaded to the resident memory of the mobile device.

19. The system of claim 17, wherein communication between the mobile device and alert device is performed wirelessly; Bluetooth; Near Field Communication.

20. The system of claim 17, wherein communication between the mobile device and alert device performed through a wired connection.

21. The system of claim 17, wherein the central monitoring system collects parameters related to a patient under medical care and wirelessly transmits the parameters to a software application resident on a mobile device.

22. The system of claim 17, wherein the central monitoring system collects parameters related to a process involving machinery and/or materials and wirelessly transmits the parameters to a software application resident on a mobile device.

23. The system of claim 17, wherein the central monitoring system collects parameters related a person, animal or other entity that requires monitoring and wirelessly transmits the parameters to a software application resident on a mobile device.

24. The system of claim 17, wherein the software application communicates to a remote observer the parameters transmitted by the central monitoring system received by the mobile device.

25. The system of claim 17, wherein the mobile device is used by a remote user who is responsible for the monitored patient, process, person, animal, entity.

26. The system of claim 17, wherein software application starts automatically when the mobile device is turned on.

27. The system of claim 17, wherein the software application is started by an owner/operator of the mobile device.

28. The system of claim 17, wherein the alert device is mechanically coupled to mobile device.

30. The system of claim 17, wherein the alert device is mechanically mounted a fixed distance from the mobile device.

31. The system of claim 17, wherein the software application communicates its operational status to an alert device.

32. The system of claim 17, wherein the alert device communicates its status to a software application.

33. The system of claim 17, wherein the software application contains the communication means for the alert device.

34. A system comprising:
a monitor that is constructed and arranged for communicating with a mobile device;
an alert device separate from the mobile device;
a software application running on the mobile device for programmatic control of communication with the monitor;
wherein the software application periodically communicates its operational status to the alert device;
the alert device periodically communicates its operational status to the software application;
the alert device being programmed with logic for delivery of notification commensurate with the operational status of the software application, and
the software application being programmed with logic for delivery of notification commensurate with the operational status of the alert device.

35. The system of claim 34, wherein the mobile device includes a software application that has been downloaded to the resident memory of the mobile device.

36. The system of claim 34, wherein communication between the mobile device and alert device is performed wirelessly; Bluetooth; Near Field Communication.

37. The system of claim 34, wherein communication between the mobile device and alert device performed through a wired connection.

38. The system of claim 34, wherein the monitor collects parameters related to a patient under medical care and wirelessly transmits the parameters to a software application resident on a mobile device.

39. The system of claim 34, wherein the monitor collects parameters related to a process involving machinery and/or materials and wirelessly transmits the parameters to a software application resident on a mobile device.

40. The system of claim 34, wherein the monitor collects parameters related a person, animal or other entity that requires monitoring and wirelessly transmits the parameters to a software application resident on a mobile device.

41. The system of claim 34, wherein the software application communicates to a remote observer the parameters transmitted by the monitor received by mobile device.

42. The system of claim 34 wherein the mobile device is used by a remote user that is responsible for the monitored patient, process, person, animal, entity.

43. The system of claim 34, wherein software application starts automatically when the mobile device is turned on.

44. The system of claim 34, wherein the software application is started by an owner/operator of the mobile device.

45. The system of claim 34, wherein the alert device is mechanically coupled to mobile device.

46. The system of claim 34, wherein the alert device is mechanically mounted a fixed distance from the mobile device.

47. The system of claim 34, wherein the software application communicates its operational status to an alert device.

48. The system of claim 34, wherein the alert device communicates its status to a software application.

49. The system of claim 34, wherein the software application contains the communication means for the alert device.

50. A system comprising:
a monitor that is constructed and arranged for communicating with a mobile device;
an alert device separate from the mobile device;
a first software application running on the mobile device for programmatic control of communication with the monitor;
a second software application running on the mobile device for monitoring the operational status of the first software application;
wherein the second software application periodically communicates its operational status of the first software application to the alert device, and
the alert device being programmed with logic for delivery of notification commensurate with the operational status of the first software application.

51. The system of claim 50, wherein the mobile device includes a software application that has been downloaded to the resident memory of the mobile device.

52. The system of claim 50, wherein communication between the mobile device and alert device is performed wirelessly; Bluetooth; Near Field Communication.

53. The system of claim 50, wherein communication between the mobile device and alert device performed through a wired connection.

54. The system of claim 50, wherein the monitor collects parameters related to a patient under medical care and wirelessly transmits the parameters to a software application resident on a mobile device.

55. The system of claim 50, wherein the monitor collects parameters related to a process involving machinery and/or materials and wirelessly transmits the parameters to a software application resident on a mobile device.

56. The system of claim 50, wherein the monitor collects parameters related a person, animal or other entity that requires monitoring and wirelessly transmits the parameters to a software application resident on a mobile device.

57. The system of claim 50, wherein the software application communicates to a remote observer the parameters transmitted by the monitor received by mobile device.

58. The system of claim 50, wherein the mobile device is used by a remote user that is responsible for the monitored patient, process, person, animal, entity.

59. The system of claim 50, wherein software application starts automatically when the mobile device is turned on.

60. The system of claim 50, wherein the software application is started by an owner/operator of the mobile device.

61. The system of claim 50, wherein the alert device is mechanically coupled to mobile device.

62. The system of claim 50, wherein the alert device is mechanically mounted a fixed distance from the mobile device.

63. The system of claim 50, wherein the software application communicates its operational status to an alert device.

64. The system of claim 50, wherein the alert device communicates its status to a software application.

65. The system of claim 50, wherein the software application contains the communication means for the alert device.
